(19) United States
(12) Patent Application Publication
(10) Pub. No.: US 2006/0012660 A1
(43) Pub. Date: Jan. 19, 2006

(54) Hand operated printing device

(76) Inventor: Hans Dagborn, Taby (SE)

Correspondence Address: NIXON & VANDERHYE, PC, 901 NORTH GLEBE ROAD, 11TH FLOOR, ARLINGTON, VA, 22203, US

(21) Appl. No.: 10/507,497

(22) PCT Filed: Mar. 10, 2003
(86) PCT No.: PCT/SE03/00390

§ 371 Date: Aug. 23, 2005

(30) Foreign Application Priority Data
Mar. 11, 2002 (SE) 0200710-2

(51) Int. Cl. B41J 3/36

(52) U.S. Cl. 347/109

(57) ABSTRACT

The invention relates to a sensor and assembly comprised in a housing for a hand-held and hand-operated printing device controlled by a processor, and a method therefor. It provides a hardware solution to speed up a print-out with said assembly.

### TECHNICAL FIELD

The present invention pertains to a sensor means and a print-head assembly for a hand-held and hand-operated printing on a print medium controlled by a processor, and a method therefore, so called Random Movement Printing Technology (RMPT). Specifically it provides a high-speed implementation of image printing with said print-head.

### BACKGROUND ART

Hand-held and hand-operated printing devices with an ink-jet print-head are known through various documents.

U.S. Pat. No. 5,927,872 by Yamada discloses a system and a method of printing an image represented by a frame of image data utilizing a hand-held printer having optical sensor means for tracking positions of the hand-held printer relative to the surface of a print medium during a printing process. It is monitored in real time using navigation information generated by the optical sensor.

Each optical sensor comprises an array of opto-electronic elements to capture images of the surface of a print medium at fixed time intervals. Preferably, the optical sensor means can detect slight pattern variations on the print medium, such as paper fibers or illumination pattern formed by highly reflective surface features and shadowed areas between raised surface features. These features can then be used as references for determining the position and the relative movement of the hand-held printer. During the printing process, the printed portions of the image can also be used as reference positions by the hand-held printer.

In the preferred embodiment, the hand-held printer contains a navigation processor and a printer driver. Using the printer driver, the navigation processor drives the hand-held printer to print segments of the image onto a print medium as the hand-held printer travels across the print medium during a printing process. Each segment of the image is printed onto a particular location on the print medium to form a composite of the image.

In the U.S. Pat. No. 6,233,368 B1 by Badyal et al it is taught a CMOS digital integrated circuit (IC) chip on which an image is captured, digitized, and then processed on-chip in substantially the digital domain.

A preferred embodiment comprises imaging circuitry including a photo cell array for capturing an image and generating a representative analog signal, conversion circuitry including an n-bit successive approximation register (SAR) analog-to-digital converter for converting the analog signal to a corresponding digital signal, filter circuitry including a spatial filter for edge and contrast enhancement of the corresponding image, compression circuitry for reducing the digital signal storage needs, correlation circuitry for processing the digital signal to generate a result surface on which a minima resides representing a best fit image displacement between the captured image and previous images, interpolation circuitry for mapping the result surface into x- and y-coordinates, and an interface with a device using the chip, such as a hand-held scanner.

The filter circuitry, the compression circuitry, the correlation circuitry and the interpolation circuitry are all embodied in an on-chip digital signal processor (DSP). The DSP embodiment allows precise algorithmic processing of the digitized signal with almost infinite hold time, depending on storage capability. The corresponding mathematical computations are thus no longer subject to the vagaries of CMOS chip structure processing analog signals. Parameters may also be programmed into the DSP's software making the chip tunable, as well as flexible and adaptable for different applications.

U.S. Pat. No. 5,644,139 by Allen et al discloses a scanning device and a method for forming a scanned electronic image including the use of navigation information that is acquired along with image data, and then rectifying the image data based upon the navigation and image information. The navigation information is obtained in frames. The differences between consecutive frames are detected and accumulated, and this accumulated displacement value is representative of a position of the scanning device relative to a reference. The image data is then positioned-tagged using the position data obtained from the accumulated displacement value. To avoid the accumulation of errors, the accumulated displacement value obtained from consecutive frames is updated by comparing a current frame with a much earlier frame stored in memory and using the resulting difference as the displacement from the earlier frame. These larger displacement steps are then accumulated to determine the relative position of the scanning device.

The above documents teach how to determine the position in a conceptual generation of navigation information. In this context the U.S. Pat. No. 5,927,872 by Yamada uses the navigation information for a hand-held scanner disclosed in U.S. Pat. No. 5,644,139 by Allen et al. The invention according to Allen et al teaches navigation through comparison of pixels on a frame basis.

There are problems related to the speed of controlling the print-head when feeding large bitmaps to be printed by a print-head.

### SUMMARY OF THE DISCLOSED INVENTION

The present invention relates to a new print-head assembly for a hand-held and hand-operated printing on a print medium controlled by a processor. Specifically it provides a hardware solution to speed up a print-out with such an assembly.

Hence, the present invention sets forth a sensor and print-head assembly comprised in a housing for a hand-held and hand-operated printing device controlled by a processor connected to at least one first electronic memory, comprising at least one sensor means, a print-head array, input means on said housing connected to said processor for input of assembly control commands, and means for keeping track of the assemblies and print-heads position on a print medium.

The processor is provided a connection to a hardware control arrangement, said arrangement comprising a programmable logic means, PLD, connected to at least one second electronic memory. It has input means for receiving measurement signals from said at least one sensor. The logic means are controlling a print-out from the print-head by computing received signals from said sensors and bitmap information stored in said second memory upon a command from the processor. This provides a mode where said logic means operates independently from the processor in controlling a print-head print operation, providing exclusive access rights for said logic means to said second memory. Another command from said processor provides a mode where said logic means is relived from controlling said print-head print operation, and thus made signal transparent to the processor.

The at least one second electronic memory is thus made reachable for storing of information controlled by the processor, thus enhancing the speed of providing data to the print-head for printing operations by allowing the processor to compute and handle received information in said first electronic memory. This avoids contest between operations on said memories.

In one embodiment of the invention, the print-head is of the ink-jet type with spray nozzles. Another embodiment provides that the nozzles are comprised in an array where each nozzle is addressed by a binary number, and whereby a fictive nozzle is used to calculate a change of position in an x and y direction for the array on a print medium as a function of the angle of rotation of the array.

A look-up table/tables in one further embodiment comprises sine and cosine values for sensor steps with a predetermined resolution between sensor steps, one of said sensor steps determining a minimum movement of the assembly. Another embodiment provides an assembly, wherein the table/tables are provided integer values, which are obtained by multiplication of the “real” values with a suitable power of 2, and whereby other values stored and used for calculations are correspondingly scaled.

A further embodiment provides that the number of binary bits in a designation of a nozzle are 7, thus addressing 127 nozzles, said fictive nozzle being No. 128, calculating the address to the bitmap in the second memory, where p is the width of a bitmap, as y₀*p+n/128*Δy₁₂₈*p+((x₀+n/128*Δx₁₂₈) div B) and the designation of the bit in the bitmap as (x₀+n/128*Δx₁₂₈) mod B.

In a still further embodiment, the bitmap resides in the upper left corner of a maximum sized memory area for a possible bitmap in the second memory, whereby the value of p is a multiple of two, thus reducing calculations to be made.

Another embodiment provides that the number of nozzle No. n is indicated by a counter, which is incremented when the preceding nozzle has accomplished its task.

Yet another embodiment provides that a position is expressed through the coordinates of the sensor means and the angle between the prior position and the current position of the sensor means.

Yet a further embodiment provides that the print-head nozzle position is computed from the knowledge of the position of one sensor means and the tilt angle of the assembly, by calculating the position of the first and last nozzle in said array. Remaining nozzle positions are, in one embodiment, computed by starting from the first nozzle positions and adding up the difference in x- and y-directions between the nozzles, whereby the x and y distance between the first and last nozzle is divided by the number of nozzles.

Another embodiment comprises that a positioning means is provided to position the assembly in a correct starting position in relation to the print medium.

### BRIEF DESCRIPTION OF THE DRAWINGS

Henceforth reference is had to the accompanying drawings for a better understanding of the given examples and embodiments of the present invention, wherein:

FIG. 1 illustrates a perspective view in section of a printing device that may be used in the present invention;

FIG. 2 illustrates a perspective view from underneath of a printing device according to FIG. 1;

FIG. 3 illustrates a schematic view of the main components of a printing device according to FIGS. 1 and 2;

FIG. 4 illustrates a perspective view of another embodiment for a printing device that may be used in the present invention;

FIG. 5 illustrates a perspective view of a simpler printing device that may be used in the present invention;

FIG. 6 schematically illustrates a sensor/print-head assembly that may be used in the present invention;

FIG. 7 illustrates a diagram with parameters used to determine the position of a sensor that may be used in the present invention;

FIG. 8 illustrates a diagram with parameters for a print-head nozzle position;

FIG. 9 illustrates an image to be print-out;

FIG. 10 illustrates a part random print-out of the image with a printer of, for example, FIG. 1; and

FIG. 11 illustrates one embodiment of a block diagram for the control of a print-head in accordance with the present invention.

### DETAILED DESCRIPTION OF PREFERRED EMBODIMENTS

The present invention relates to a new print-head assembly for a hand-held and hand-operated printing on a print medium controlled by a processor. Specifically it provides a hardware solution to speed up a print-out with such an assembly. A detailed description of the hardware print-out in accordance with the present invention is provided with reference to FIG. 11 below.

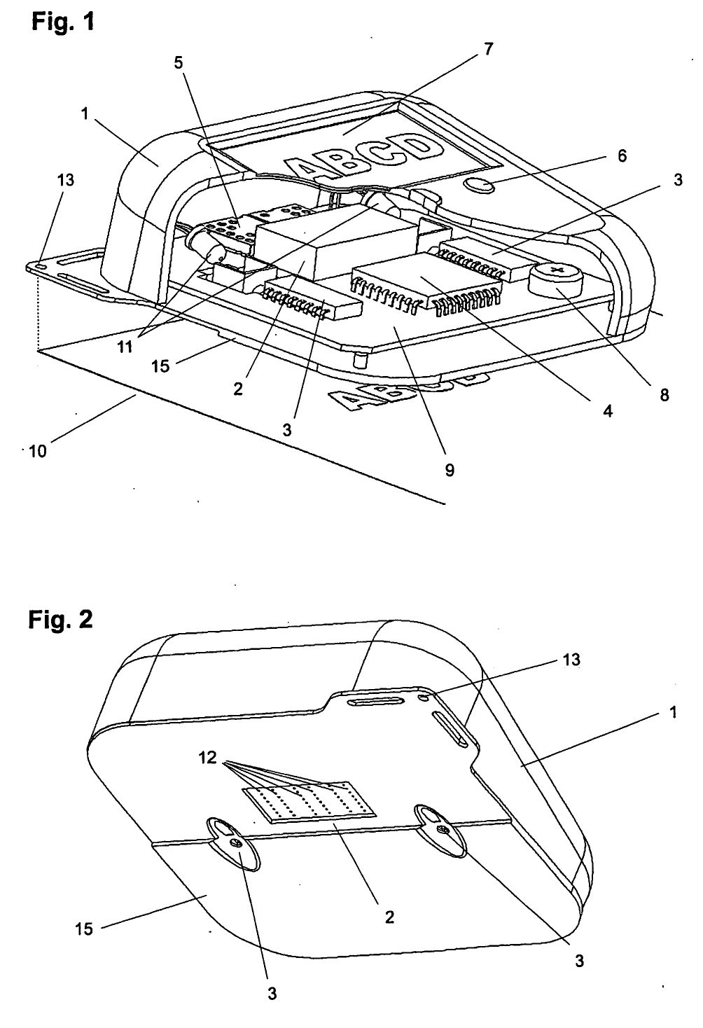

FIG. 1 to FIG. 10 disclose or relate to a hand-held printer device as described in the Swedish patent application 0102542-8 by Walling, not yet published, which substitutes both the mechanical control of a print-head and forward feeding of a print-out through hand movements on a printing surface. This enables a manufacturing of a printer device, having less width than the actual print-out, and a reduction of the total of mechanical components in its construction.

It is designed to provide a compact portable printing device in order to enable a user to print from small portable devices such as a cellular phone, a portable PC, a personal digital assistance (PDA) or the like, and other portable electronic devices or for electronic stamping, printing of small texts, tags, addresses, cutting and clipping.

By fixing a print-head in a construction plate where one or more positioning sensor means are fixed as well, it is possible to obtain a geometrical construction with an x- and y-coordinate system and to establish, with great mathematical accuracy, the coordinates x and y for each individual ink-jet opening/nozzle in the print-head.

The coordinates, during a time frame, constitute the grounds for an accurate and precise spraying of ink-drops onto a printing surface according to a predetermined printing design. Even when the coordinates change over a time period, it is possible to calculate in real time, the changes in direction, speed, acceleration, rotation etc. along the z-axis controlled by a microprocessor. It provides the possibility to adjust the printing-head to spray an even and pre-programmed flow of ink-jet drops into an adjustable and varying flow of ink-jet drops.

FIGS. 1 and 2 illustrate a hand operated printing device composed by a construction/design body 1 and a print-head 2 which interact with one or more optical positioning sensor means 3, a micro controller circuit 4, a communication unit 5 to transmit the data, one or more command buttons 6 a control screen, and a source of energy, in this case a battery 8.

The embodiment according to FIGS. 1 and 2 illustrate the different components of a printing device fixed to a printed circuit card which simultaneously functions as a construction surface where those components are fixed. An elevation in the construction secures that the lowest surface of the printing device does not touch the area where the ink has been previously applied provided that the printing device is removed from that area.

The printing process starts with a data file containing pre-selected printing patterns, which are sent via the communication unit 5 to a data memory, for example, one which is built into the micro controller circuit 4. With the assistance of a built-in positioning sensor means 13 and one of the command buttons 6 the coordinates are indicated to an outgoing point of reference in the printing surface. One or more sources of light, for example light emitting diodes (LED), lighting up the printing frame so that the optical positioning sensor means are activated and then the forward feeding of the coordinates to the micro controller circuit can take place.

When the positioning sensor means 3 and the print-head 2 are fixed in relation to each other, a geometrical construction with all the necessary parameters for a mathematical calculation of the coordinates of the print-head 2 can be achieved.

The micro controller circuit 4 contains a software program, which uses the incoming data from the positioning sensor means 3 and mathematical equations to calculate in real time the coordinates for each individual ink-jet nozzle 12.

Using the measures of two coordinates establishes the required movement direction for each case. The time difference between two measurements indicates the acceleration and speed required. Simultaneously all measurements and equations are compared with the stored printing commands based upon coordinates equated from the original data file.

At this stage the micro controller circuit has sufficient information to seize a decision. On a positive indication an electric impulse is generated in the piezo- or termo-electrical micro pumps in the concerned ink-jet nozzles 12, which in turn sends out ink-jet drops onto the printing surface.

The printing commands are erased after each electric impulse so that even if the ink-jet nozzles coincide with the previous coordinates no ink drops are sent out to the existing print-out.

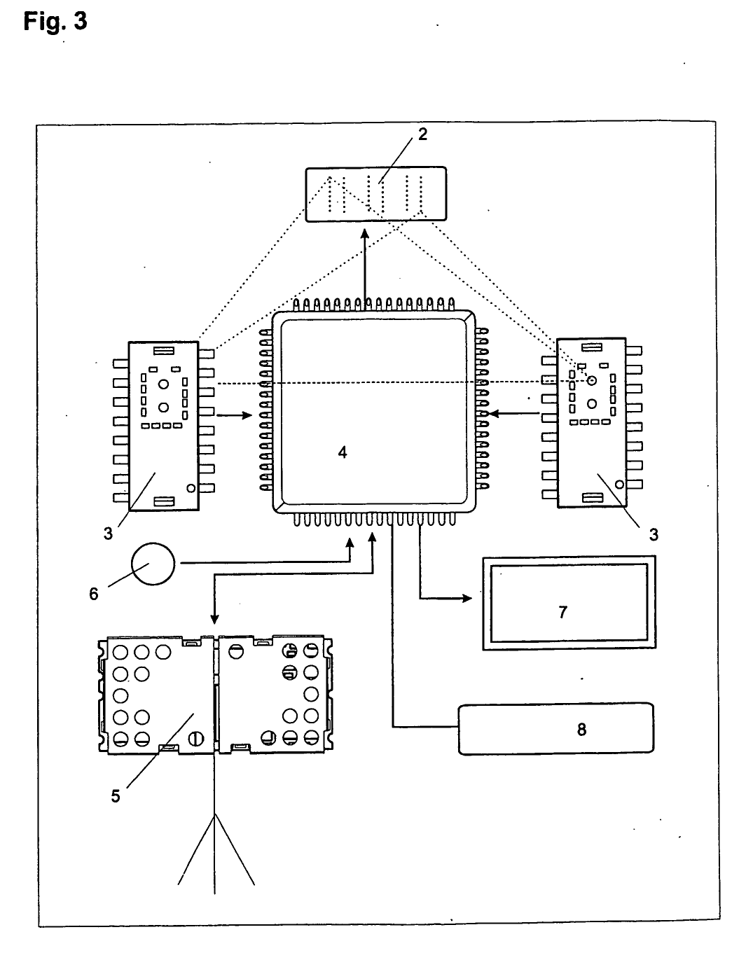

FIG. 3 illustrates how the different components of the printing device interact as well as reproduction of the geometrical forms established between the ink-jet nozzles 12 and the positioning sensor means 3.

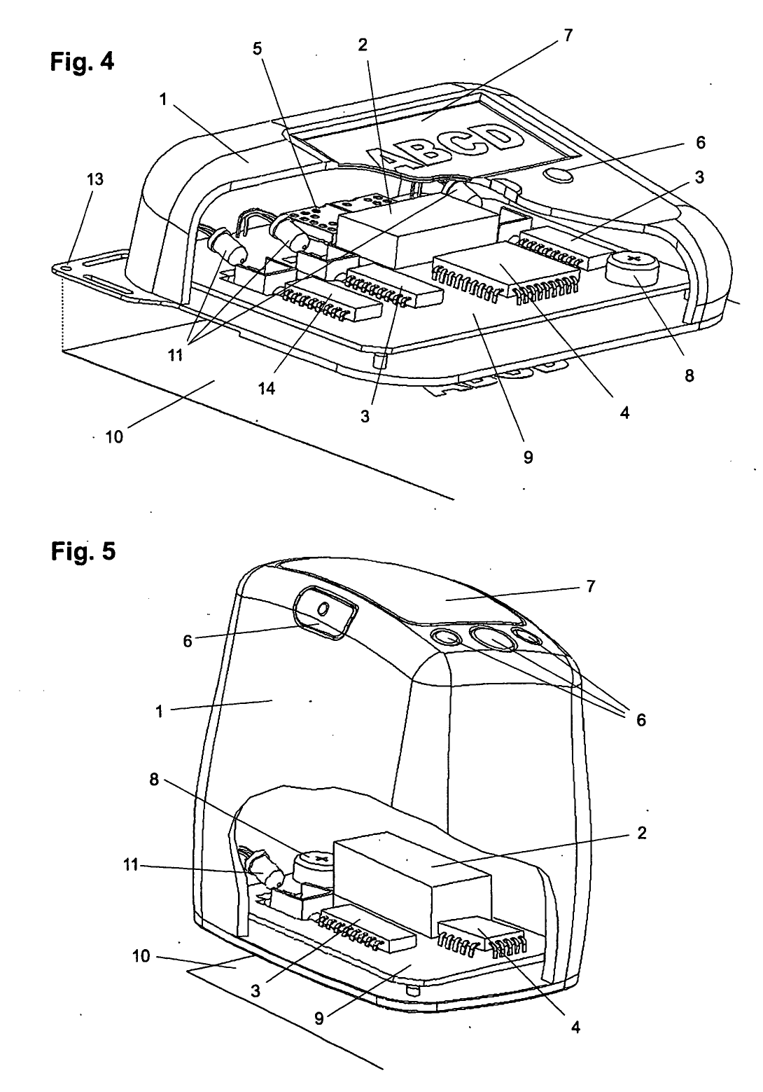

The embodiment according to FIG. 4 illustrates the printing device with a complementary digital camera 14, for example, such as a CCD equipped camera.

FIG. 5 illustrates another embodiment for printing of smaller text quantities or graphics.

This can be considered as an electronic labeling with a pre-programmed and/or programmable electronic stamp pad.

In this embodiment only one positioning sensor means 3 is used and accordingly a simpler micro controller circuit 4 is needed, since the printing device only makes smaller and relatively straight movements.

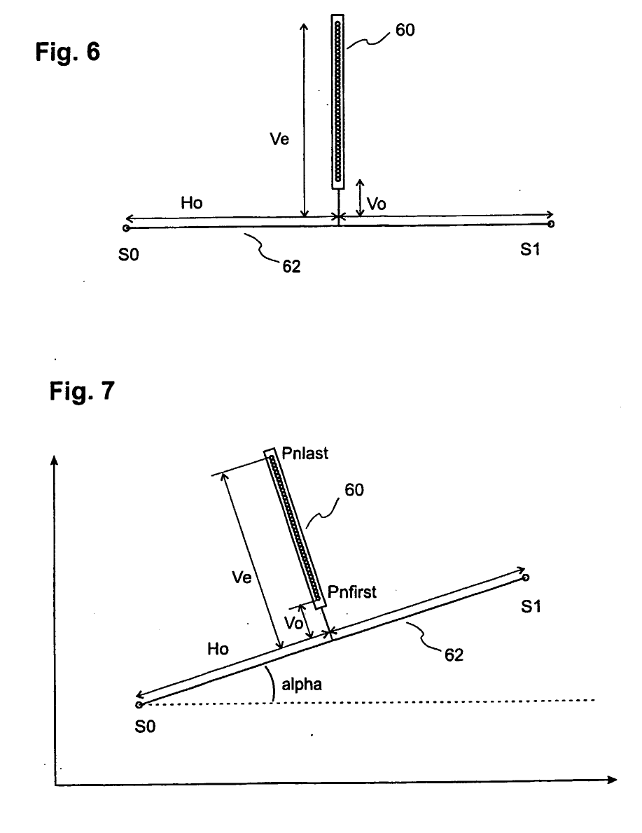

The sensor/print-head device consists of two position sensor means S0, S1 and a print-head array 60 mounted together as FIG. 6 illustrates. FIG. 6 illustrates further, the two sensor means S0 and S1 in a fixed relation to a print-head array 60 with ink-jet nozzles. Ho depicts the distance from the array 60 to the sensor means S0, here Ho constitutes the same distance to the sensor means S1. Ve and Vo, indicate the distance to the upper most and the lover nozzle in the array 60, respectively. The sensor means S0, S1 provide a signal corresponding to movements in x- and y-directions in a first coordinate system fixed to the respective sensor means S0, S1. The sensor means S0, S1 are fixed so that their coordinate systems are parallel to each other. A software keeps track of the assembly's position and angle relative to the paper coordinate system by integrating the movements given by the sensor means signals.

The new positions given the differential movements of sensor means S0, S1 are calculated as follows.

All position changes given in the sensor means coordinate system must be transformed to position and angle of the sensor system in a paper or other print medium coordinate system, here named as a second coordinate system. Since the distance, 2 Ho, between the two sensor means is fixed it is satisfactory to know the position of one sensor means and the angle of the print-head array relative to the second coordinate system.

Illustrated in FIG. 7, is a movement or navigation of the sensor print-head assembly according to FIG. 6. The array 60 has been moved or navigated an angle alpha. The upper most nozzle is depicted as Pnlast and the lower nozzle as Pnfirst, respectively, in FIG. 7. Also, the second coordinate system is depicted with the two longer arrow axis in FIG. 7.

In FIG. 7 at least one of the sensor means is assigned a first coordinate system, whereby one axis 62, preferably the x-axis, is directed through both sensor means S0, S1, and the other axis, preferably in a relation to the array 60, here in parallel to the array.

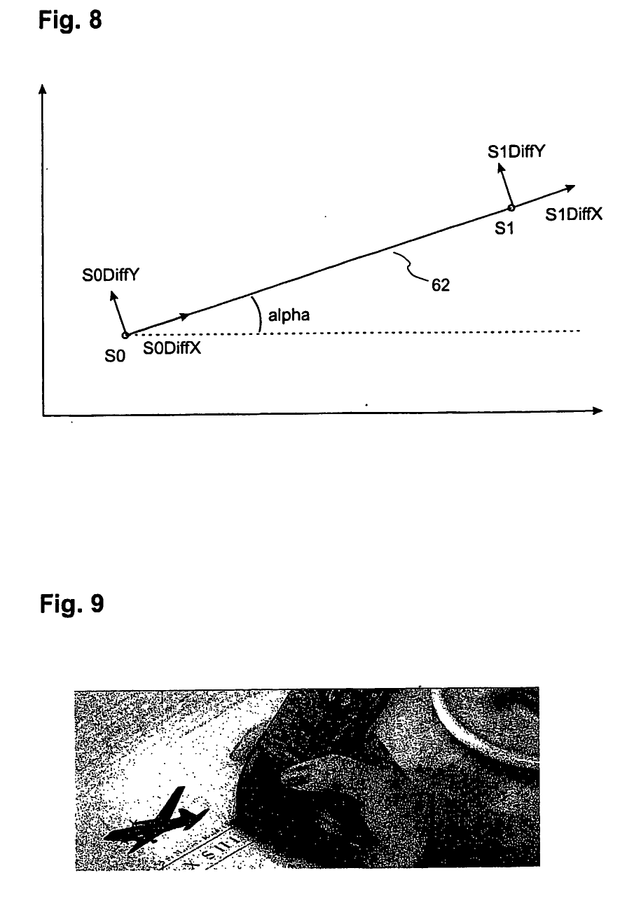

In FIG. 8, the same movement as in FIG. 7 is depicted, but without the array 60. The FIG. 8 further depicts a first coordinate system on the coordinate axis 60 directed through both sensor means S0, S1. The first coordinate system, is in this embodiment duplicated, as indicated through the arrows on the axis 62, but as the distance between both sensor means S0, S1 is fixed only one of the first coordinate systems is needed for computation.

The movement of the sensor means S0 or S1 (it does not matter which one) in the paper or print medium second coordinate system at an angle ‘alpha’ is calculated, as:
deltaX=S0DiffX*cos(alpha)−S0DiffY*sin(alpha)
deltaY=S0DiffX*sin(alpha)+S0DiffY*cos(alpha)

Where S0DiffX and S0DiffY are the movements of the sensor means in x- and y-directions respectively, in the sensor/print-head device, named first coordinate system.

The angular change can be calculated as the difference of the sensor means y-movements in the sensor means first coordinate system multiplied by a constant that is determined from the distance between the sensor means S0, S1. To simplify, the angle is measured in units of one sensor “step” and the sine and cosine values are taken from tables that are adjusted according to this. Thus S1DiffY-S0DiffY, provides the angle change.

The movement in x-direction of sensor means S1 is not used, the information is redundant since the sensor means geometry is fixed.

When the position of one sensor means S0 or S1 and the tilt angle of the sensor/print-head assembly alpha are known the positions of the print-head nozzles can be calculated as follows, depicted in FIG. 7:

The positions of the first and last nozzle are calculated as:
PNfirstX=S0x+Ho*cosine(alpha)−Vo*sine(alpha)
PNfirstY=S0y+Ho*sine(alpha)+Vo*cosine(alpha)
PNlastX=S0x+Ho*cosine(alpha)−Ve*sine(alpha)
PNlastY=S0y+Ho*sine(alpha)+Ve*cosine(alpha)

To calculate the positions of all nozzles, it is to start with the first nozzle positions and adding up the difference in x- and y-directions between the nozzles, calculated by dividing the x- and y-distance between the first and last nozzle by the number of nozzles:
PN(n)=PNfirstX+n*deltaX
PN(n)Y=PNlast+n*deltaY
where
deltaX=PNlastX−PNfirstY
deltaY=PNlastY−PnfirstY

In accordance with the teaching it sets forth a sensor and ink-jet print-head 2 assembly comprised in a housing 1 for a hand-held and hand-operated printing device controlled by a processor 4. It thus comprises:
two position sensor means S0, S1 at least one sensor means being related to a first coordinate system, having one axis in a relation to the print-head assembly, and one axis 62 in a direction through both sensor means;
a print-head array 60 attached in a fixed position to the sensor means S0, S1;
input means 6 on the housing connected to the processor for input of control commands;
determining means for reference coordinates in a second coordinate system provided in relation to a print medium, the reference coordinates being established by a control command through the input means 6 with the thus read sensor means signals;
integrating means for keeping track of the assemblies position related to the reference coordinates in the second coordinate system by integrating displacement of the sensor means position in the first coordinate system;
   computing means for transforming the sensor means S0, S1 coordinates to coordinates in the second coordinate system, whereby the assemblies position on the print medium is determined in relation to the reference coordinates.

Sensor means and print-heads that are suitable to use are well known in the art and described in for example U.S. Pat. No. 5,927,872 by Yamada, U.S. Pat. No. 6,233,368 B1 by Badyal et al, and U.S. Pat. No. 5,644,139 by Allen et al. Sensor means can be bought from Agilent, www.agilent.com. Another sensor means has the product name HDNS-2000 and enables 1.500 pitures/s, the next model in progress enables 6.000 pictures/s. Sensor means in this description can comprise known means that are to cooperate together with a sensor itself, for example, LEDs or only be sensors or an array of sensors.

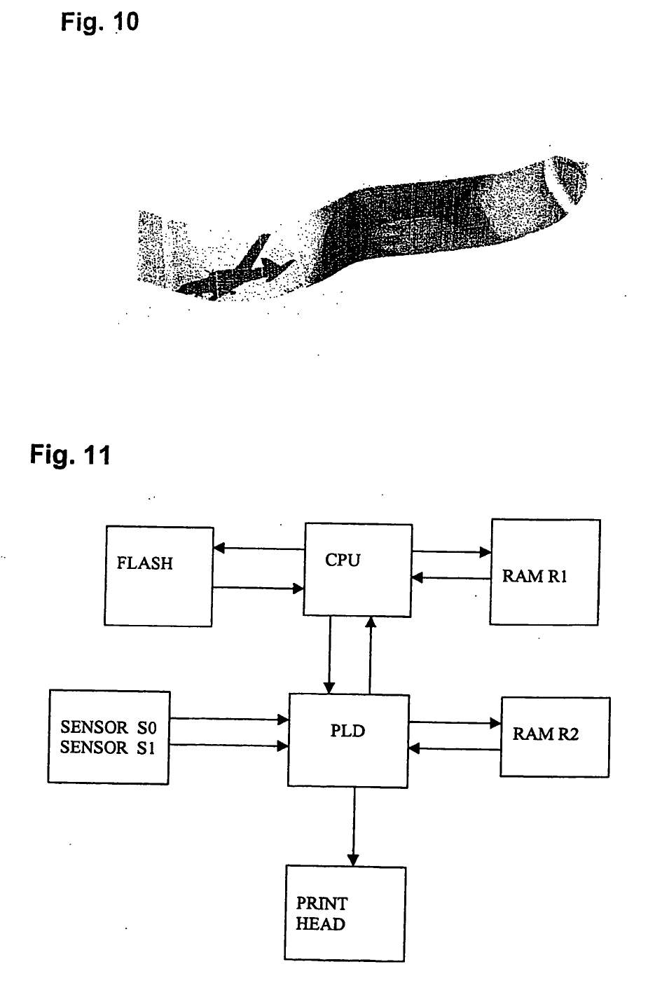

FIG. 9 illustrates an image to be print-out with the assembly, thus stored in the assembly's memory, and FIG. 10 depicts a part print-out in a random movement.

Illustrated in FIG. 11 is one embodiment of a block-diagram for the control of a print-head in accordance with the present invention.

In order to feed data to a print-head for random printing with maximum speed a hardware solution is implemented in accordance with the present invention, which in one embodiment utilizes a print-head assembly with two optical sensors S0 and S1 as described in the foregoing. The hardware solution is depicted in FIG. 11. Depicted Flash and RAM memories R1 are provided, as known to a person skilled in the art, for the conventional functioning of a CPU to perform print-outs. The flash memory conventionally acts as a non-volatile electrically write able/erasable storage holding, for example, the BIOS and the bootstrap instruction set for the CPU functions.

Conventionally the CPU would be used to control the print-head through software. During the R&D process of the present invention it has shown that a software control of print-outs is a far to slow process for making use of the 2 Mbit/s maximum data-speed of the print-head. It is thus appreciated that said data-speed relates to a currently used print-head, and that a constant further technical ongoing process for higher speeds is in progress. In order to fully make use of the print-head printing speed, a hardware solution in accordance with the present invention is presented.

The CPU constantly unpacks and receives images for print-out in its main memory RAM R1, which makes it busy with unwanted tasks during a printout when it should be totally engaged in the print-out, and not involved in context switching and/or dealing with interruption signals. An obvious measure to take for a person skilled in the art would be to enlarge the memory space RAM R1 directly controlled by the CPU in order to come up with a suitable software solution handling the print-out speeds of the print-head assembly.

Instead of having a software control for print-outs, the present invention introduces a different approach through mostly pure hardware. The hardware solution addressing mainly the speed problem is provided through an extra RAM memory R2 connected to the CPU via a PLD (Programmable Logic Device). When a bitmap for a print-out is being prepared, the PLD is put in an inactive state through signalling from the CPU, thus being made transparent for data transfer between the CPU and devices connected to the PLD such as RAM R2. This means that the CPU experiences R2 as a conventional memory area directly connected to the CPU.

At power-on the CPU calculates cosine and sine-tables needed, storing them transparently through the PLD in R2. Sine and cosine tables, and their utilization, have been explained in the foregoing. A specific implementation of the table/tables comprises that they are provided integer values, which are obtained by multiplication of the “real” values with a suitable power of 2, for example, 2¹⁶. Other values stored and used for calculations are correspondingly scaled. In doing so, every calculation may be performed using integer values, which saves from using an overhead of logic in the PLD. It also enhances the speed of calculation.

Further, the PLD is connected to position sensors, here S0 and S1, managing the handling of the print-head print medium position information received from the sensors.

During reception through the CPU of a complete image/picture for printing, the CPU prepares a bitmap of the image in memory R1, and stores it in memory R2, in such a manner that every pixel in the bitmap is corresponding to one “tick” from the sensors S0, S1, which in one embodiment are opto-electronic devices (optosensors). Concurrently, the size of the provided bitmap is stored in memory R2. When the bitmap is prepared, the CPU writes a start command to the PLD, which operates to disconnect the CPU from RAM memory R2.

The PLD is now acting on its own together with the RAM memory R2 and the sensors S0, S1, making up the hardware print-head control arrangement in accordance with one embodiment of the present invention, until the CPU writes a stop command to a provided command register. For every detected change of a position registered and reported to the PLD by optosensors, the PLD calculates a new position for the, in this embodiment, provided 128 ink-jet spray nozzles, and transmits the so called dot information to the print-head controlling it to print dots from designated nozzles.

It is thus appreciated that the present invention comprises at least two modes of operation for the CPU vis-à-vis the PLD, and vice versa.

Hence, providing a mode where the logic means (PLD) operates independently from the processor (CPU) in controlling a print-head print operation; and
a further command from the processor (CPU) providing a mode where the logic means (PLD) is relived from controlling the print-head print operation, and thus made signal transparent to the processor (CPU).

When a change in the position has been observed, the PLD is programmed to keep in memory where nozzle No. 0, comprised in the print-head, is positioned. Furthermore, it keeps track of how the print-head is oriented and proceeds to access the sine-cosine table in R2. The value fetch or read is the offset in x- and y-direction of nozzle No. 128 as a function of the angle of rotation of the print-head. This 128^{th} nozzle is a fictive nozzle used for making calculations smoother and easier. By introducing a fictive nozzle a division is accomplished by dividing with 128 in binary numbers which is a simple right shift in seven steps when calculating through integer arithmetic's. If 127 nozzles are used, a division in the below formulas, has to be performed two times for the address and once for the number of the bit.

In accordance with the above measures taken, the PLD is provided the necessary information such as the size of the bitmap and relevant information regarding the position of the print-head.

Due to that the maximum clock rate of the print-head (serial data), of a specific embodiment is 2 MHz, it does not make sense calculating the print information any faster. Hence, the time available to calculate, if a dot is to be printed or not, and to clear the corresponding position in the bitmap, is approximately 500 nano seconds, i.e., a 2 MHz clock rate makes 1 bit/500 ns.

By using the provided information the PLD keeps track on which bit in the bitmap that is corresponding to the position of nozzle No. 0. Assuming that the “width” of the bitmap is p and the address of this pixel is x₀/y₀, the address to the corresponding byte in the RAM memory R2 is y₀*p+x₀/8, and the number of the bit in this byte is x₀ mod 8. For nozzle no. 128 the offset in the x- and y-directions are fetch by looking them up in said sin/cos table. Hence, it is made easy in accordance with the present invention to calculate the address in the RAM memory R2 for every intermediate nozzle with the following formula:
The address=y₀*p+n/128*Δy₁₂₈*p+((x₀+n/128*Δx₁₂₈)div8)
The number of the bit=(x₀+n/128*Δx₁₂₈)mod 8
where n is the number of the nozzle. It is to be noted that calculations should be carried out in such an order that as little as possible precision is lost.

Described calculations are thus relatively convenient to implement in hardware. A division by 128 is merely a shift by 7 positions. The division “div 8” is only a shift by 3 positions. In order to simplify even more, it can be prescribed that the bitmap shall reside “in the upper left corner” of a maximum size memory area related to the bitmap. The value of p is then always a multiple of 2, which does not impose any restrictions to the design of its memory R2, because said memory area has to be available for a maximum size bitmap. If this case is prevailing, a multiplication can be eliminated, which makes the following calculations necessary:
y₀*p A shift by a fixt number of steps
x₀/8 A shift by 3
n/128*p*Δy₁₂₈ A multiplication n*Δy₁₂₈ (7×7 bits) (p/128 is a fixed multiple of 2 and requires only a shift operation)
x₀+n/128*Δx₁₂₈ A multiplication*Δx₁₂₈ (7×7 bits)

As the position in a bitmap for successive nozzles is calculated, it becomes unnecessary to accomplish the multiplikation n*Δy₁₂₈ in the expression n/128*p*Δy₁₂₈ The value 1/128*p*Δy₁₂₈ is known and constant. For the first nozzle n equals 0 and is thus not used. A next step to take is to add this constant value for every new nozzle in a calculation. In accordance with this a multiplication is substituted with a simple addition.

Other operations are accomplished through shift and addition operations. These few operations can easily be implemented in a PLD of a moderate size. Its finther appreciated that the div 8 and mod 8 operations i.e. an 8 bit binary designation of course is only one of a plurality, thus to generalize the variable B is used in the attached set of claims to implicate other binary operations then 8 bit binary.

In order to calculate values for the nozzles, a counter can be used to indicate the value n. As soon as an address to a desired byte in memory R2 is calculated, it is read from RAM R2. The value of the bit in question becomes noted, the bit is cleared and a thus modified byte is written back to the same address. This is followed by incrementing the counter as addresses to each nozzle from 0 to 127 are determined in a stored bitmap. Performing the calculation necessary for a pixel provides that only two memory accesses are needed, one read- and one write-access to the same memory address. It is possible (even probable) that the same byte will be read and written more than once in order to make the calculations for adjacent pixels.

It is appreciated that some of the means used in the present invention are hardware means or software means or a combination of both.

The present invention is not restricted to given embodiments or examples, but the attached set of claims define other embodiments for a person skilled in the art.

1. A sensor and print-head assembly comprised in a housing for a hand-held and hand-operated printing device controlled by a processor connected to at least one first electronic memory, comprising at least one sensor means, a print-head array, input means on said housing connected to said processor for input of assembly control commands, and means for keeping track of the assemblies and
print-heads position on a print medium, characterized in that said processor is provided a connection to a hardware control arrangement, said arrangement comprising a programmable logic means connected to at least one second electronic memory, and having input means for receiving measurement signals from said at least one sensor, said logic means controlling a print-out from the print-head by computing received signals from said sensors and bitmap information stored in said second memory upon a command from the processor;
providing a mode where said logic means operates independently from the processor in controlling a print-head print operation, providing exclusive access rights for said logic means to the second memory;
a further command from said processor providing a mode where said logic means is relived from controlling said print-head print operation, and thus made signal transparent to the processor and
whereby said at least one second electronic memory is reachable for storing of information controlled by the processor thus enhancing the speed of providing data to the print-head for printing operations by allowing the processor to compute and handle received information in said first electronic memory, thus avoiding contest between operations on said memories.

2. An assembly according to claim 1, wherein the print-head is of the ink-jet type with spray nozzles.

3. An assembly according to claim 2, wherein the nozzles are comprised in an array where each nozzle is addressed by a binary number, and whereby a fictive nozzle is used to calculate a change of position in an x and y direction for the array on a print medium as a function of the angle of rotation of the array.

4. An assembly according to claim 1, wherein a look-up table/tables comprises sine and cosine values for sensor steps with a predetermined resolution between sensor steps, one of said sensor steps determining a minimum movement of the assembly.

5. An assembly according to claim 4, wherein the table/tables are provided integer values, which are obtained by multiplication of the “real” values with a suitable power of 2, and whereby other values stored and used for calculations are correspondingly scaled.

6. An assembly according to claim 2, wherein the number of binary bits in a designation are 7, thus addressing 127 nozzles, said fictive nozzle being 128, calculating the address to the bitmap in the second memory, where p is the width of a bitmap, as y₀*p+n/128*Δy₁₂₈*p+((x₀+n/128*Δx₁₂₈) div B) and the designation of the bit in the bitmap as (x₀+n/128*Δx₁₂₈) mod B.

7. An assembly according to claim 6, wherein the bitmap resides in the upper left corner of a maximum sized memory area for a possible bitmap in the second memory, whereby the value of p is an multiple of two, thus reducing calculations to be made.

8. An assembly according to claim 6, wherein the number of nozzles n is indicated by a counter, which is incremented when the preceding nozzle has accomplished its task.

9. An assembly according to claim 1, wherein a position is expressed through the coordinates of the sensor means and the angle between the prior position and the current position of the sensor means.

10. An assembly according to claim 2, wherein the print-head nozzle position is computed from the knowledge of the position of one sensor means and the tilt angle of the assembly, by calculating the position of the first and last nozzle in said array.

11. An assembly according to claim 10, wherein remaining nozzle positions are computed by starting from the first nozzle positions and adding up the difference in x- and y-directions between the nozzles, whereby the x- and y-distance between the first and last nozzle is divided by the number of nozzles.

12. An assembly according to claim 1, wherein a positioning means is provided to position the assembly in a correct starting position in relation to the print medium.
